(19) United States
(12) Patent Application Publication
(10) Pub. No.: US 2015/0353686 A1
(43) Pub. Date: Dec. 10, 2015

(54) HIGHLY PERMEABLE AND HIGHLY SELECTIVE POLYIMIDE COPOLYMER AND METHOD FOR SYNTHESIZING SAME

(71) Applicant: AEKYUNG PETROCHEMICAL CO., LTD., Seoul (KR)

(72) Inventors: Jung Moo LEE, Daejeon (KR); Myung-Gun LEE, Daejeon (KR)

(21) Appl. No.: 14/760,101

(22) PCT Filed: Feb. 20, 2013
(86) PCT No.: PCT/KR2013/001331

§ 371 Date: Jul. 9, 2015

(30) Foreign Application Priority Data
Jan. 15, 2013 (KR) 10-2013-0004204

(51) Int. Cl. C08G 73/10

(52) U.S. Cl. CPC C08G 73/1067

(57) ABSTRACT

Provided are a high-molecular weight polyimide used for a gas separation membrane and a method for synthesizing the same. The polyimide contains 4,4′-(hexafluoroisopropylidene)diphthalic anhydride, 2,3,5,6-tetramethyl-1,4-phenylenediamine, and 1,3-bis[2-(4-aminophenyl)-2-propyl]-benzene. According to the present invention, a gas separation membrane having high oxygen permeability and high oxygen selectivity may be provided.

### TECHNICAL FIELD

The present invention relates to a highly permeable and highly selective polyimide copolymer used in a gas separation membrane and a method for synthesizing the same.

### BACKGROUND ART

In general, a gas separation membrane is a membrane used to separate gas such as oxygen, nitrogen, carbon dioxide, and the like. When a gas mixture comes in contact with a surface of a membrane, gaseous ingredients are dissolved in the membrane to thereby be diffused. In this case, solubility and permeability of each of the gaseous ingredients may be different from each other depending on a raw material of the gas separation membrane.

In the gas separation membrane, driving force with respect to gas separation is a partial pressure difference for a specific gaseous ingredient applied to both ends of the membrane. Particularly, a membrane separation process using a separation membrane has been widely applied in various fields due to advantages such as no phase change, and low energy consumption.

OBIGGS is an abbreviation for On Board Inert Gas Generation System, and there are an aircraft OBIGGS and a marine OBIGGS. The aircraft OBIGGS has been used to prevent fuel in a fuel tank from exploding in case of static electricity, lightening, or the like, and the aircraft OBIGGS is used to provide safety of an airplane body, pilots, and passengers in case of an emergency. Currently, the aircraft OBIGGS has been applied to all airplanes, such as fighter planes, civil airplanes, military helicopters, civil helicopters, and the like. In the marine OBIGGS, an inert gas generator has been used in order to prevent fire in an LNG carrier or a chemical tanker in which fire may occur. In most of the inert gas generator currently used in the fields as described above, a gas separation membrane has been used. In order to be applied to a gas separation membrane for an OBIGGS, a material should be stable at a high temperature for separating air generated in an aircraft turbine, or the like, and thus, research into application of various heat resistant polymers has been conducted.

In the case of using a heat resistant polyimide as a material of the gas separation membrane, the heat resistant polyimide, which is a glassy polymer, has high selectivity, but has a low permeability coefficient, such that it is difficult to apply the heat resistant polyimide to gas separation, and thus, a chemical structure thereof should be improved for increasing permeability. In addition, the heat resistant polyimide does not have good solubility, such that it is difficult to process the heat resistant polyimide into the separation membrane. Therefore, as a method for increasing the permeability coefficient and improving solubility, chemical structures of polyimides have been improved using various kinds of monomers, and novel polymer materials have been developed by various synthesis methods. Further, various researches into a highly permeable, highly selective, and heat resistant polyimide polymer material have been conducted.

4,4′-(hexafluoroisopropylidene)diphthalic anhydride (6FDA)-2,3,5,6-tetramethyl-1,4-phenylenediamine (4MPD) constituting the polyimide has a high glass transition temperature, a low dielectric constant, and a fine porous structure due to a rigid structure thereof, such that a soluble and highly heat resistant polyimide may be obtained. Further, a polyimide obtained by polymerization has a high fractional free volume (FFV) and d-spacing, thereby having high gas permeability. Since 6FDA-4MPD has properties that are difficult to be found in the polyimide, various researches using 6FDA-4MPD have been conducted, and in this regard, 6FDA-4MPD has been disclosed in Polymer 42 (2001) pp. 8847-8855 (Non-Patent Document 1).

However, there is a problem in that selectivity of the polyimide in selectively separating gas is low. In order to solve this problem, polymer materials using a cross-linked or copolymerized polyimide have been various studied.

Further, the polyimide is lacking in reproducibility of a gas permeation property and mechanical strength due to a low molecular weight, such that it is difficult to process the polyimide into the separation membrane. Therefore, a polymer having a molecular weight (Mw) of 150,000 has been required.

### RELATED ART DOCUMENT

### Non-Patent Document

(Non-Patent Document 1) Polymer 42 (2001) pp. 8847-8855

### DISCLOSURE

### Technical Problem

An object of the present invention is to provide a polyimide having a high molecular weight, a low polydispersity index, and excellent oxygen permeability and oxygen/nitrogen selectivity.

Another object of the present invention is to provide a method of synthesizing a polyimide capable of obtaining a polymer material having high permeability and high oxygen/nitrogen selectivity, increasing a molecular weight, and manufacturing a gas separation membrane by purifying a prepared polyimide.

### Technical Solution

In one general aspect, a polyimide contains 4,4′-(hexafluoroisopropylidene)diphthalic anhydride, 2,3,5,6-tetramethyl-1,4-phenylenediamine, and 1,3-bis[2-(4-aminophenyl)-2-propyl]-benzene.

A content ratio of 2,3,5,6-tetramethyl-1,4-phenylenediamine and 1,3-bis[2-(4-aminophenyl)-2-propyl]-benzene may be 1:9 to 9:1.

A molecular weight of the polyimide may be 150,000 to 1,000,000 (g/mol) and a polydispersity index (PDI) thereof may be 1.5 to 3.5.

In other general aspect, a method of manufacturing a gas separation membrane includes: synthesizing a polyamic acid containing 4,4′-(hexafluoroisopropylidene)diphthalic anhydride, 2,3,5,6-tetramethyl-1,4-phenylenediamine, and 1,3-bis[2-(4-aminophenyl)-2-propyl]-benzene; and imidizing the polyamic acid to prepare a polyimide.

A molecular weight (Mw) of the polyimide may be 150,000 to 1,000,000 (g/mol) and a polydispersity index (PDI) thereof may be 1.5 to 3.5.

The method may further include purifying the prepared polyimide using a mixed solvent of methanol and N,N-dimethylacetamide (DMAc).

A gas separation membrane manufactured by the method as described above may have oxygen permeability of 20 to 120 Barrers and oxygen selectivity of 2 to 6.

In another general aspect, a gas separation membrane is manufactured as described above.

Hereinafter, the present invention will be described in more detail.

The present inventors found that a gas separation membrane having excellent oxygen permeability and oxygen/nitrogen selectivity may be provided by preparing a polyimide containing 4,4′-(hexafluoroisopropylidene)diphthalic anhydride, 2,3,5,6-tetramethyl-1,4-phenylenediamine, and 1,3-bis[2-(4-aminophenyl)-2-propyl]-benzene and applying the polyimide as a gas separation membrane, thereby completing the present invention.

Polyimides have been already commercialized as a gas separation membrane due to excellent thermal, mechanical, and physical properties thereof, and recently, research into polyimides as a pervaporation membrane has also been conducted. Since the polyimides may be synthesized by reacting various kinds of dianhydrides and diamines with each other, permeation characteristics of membranes may be variously controlled depending on the kind of monomers.

Among the dianhydrides, 4,4′-(hexafluoroisopropylidene)diphthalic anhydride (6-FDA) has high selectivity for gas separation due to a limitation in mobility and a charge degree of a chain, and since formed free volume is large, permeability may be improved.

Most of the polyimide membranes based on 4,4′-(hexafluoroisopropylidene)diphthalic anhydride (6-FDA) are excessively swelled, such that permeability may be improved, but selectivity may be significantly decreased. In order to solve this problem, after several studies, the present inventor studied a polyimide based on 6-FDA, having a molecular weight of 150,000 to 1,000,000 (g/mol) and a polydispersity index of 1.5 to 3.5, and a method of preparing the same, thereby completing the present invention.

In one general aspect, the present invention provides a polyimide containing 4,4′-(hexafluoroisopropylidene)diphthalic anhydride, 2,3,5,6-tetramethyl-1,4-phenylenediamine, and 1,3-bis[2-(4-aminophenyl)-2-propyl]-benzene.

Here, 2,3,5,6-tetramethyl-1,4-phenylenediamine (4MPD), which is a diamine having four methyl substituents, serves to maintain a distance between polymer chains due to a rigid structure to increase a fractional free volume (FFV) to thereby increase gas permeability.

1,3-bis[2-(4-aminophenyl)-2-propyl]-benzene (BAPB), which is a diamine, serves to increase flexibility of a structure itself due to CH₂ contained in a structure thereof to thereby allow the polyimide to be more easily dissolved in an organic solvent.

The polyimide prepared using the dianhydride and two kinds of diamines as described above is a novel random 6FDA-4MPD-BAPB copolymer, and may have a molecular weight of 150,000 to 1,000,000 (g/mol) and a polydispersity index of 1.5 to 3.5.

In this case, a content ratio of each ingredient is not particularly limited. Particularly, a content ratio of 2,3,5,6-tetramethyl-1,4-phenylenediamine (4MPD) and 1,3-bis[2-(4-aminophenyl)-2-propyl]-benzene (BAPB) is adjusted in a range of 1:9 to 9:1, thereby making it possible to provide a polyimide having the desired gas permeation characteristics. When a content of 2,3,5,6-tetramethyl-1,4-phenylenediamine is increased within the above-mentioned range, gas permeability is increased, but selectivity is decreased. On the other hand, when a content of 1,3-bis[2-(4-aminophenyl)-2-propyl]-benzene is increased, selectivity is increased, but gas permeability is decreased.

Next, a method of preparing a polyimide will be described in detail.

First, a synthesis mechanism of a polyimide according to the present invention is as illustrated in the following Reaction Formula 1.

[Reaction Formula 1] Synthesis Mechanism of 6FDA-4MPD-BAPB Polyimide

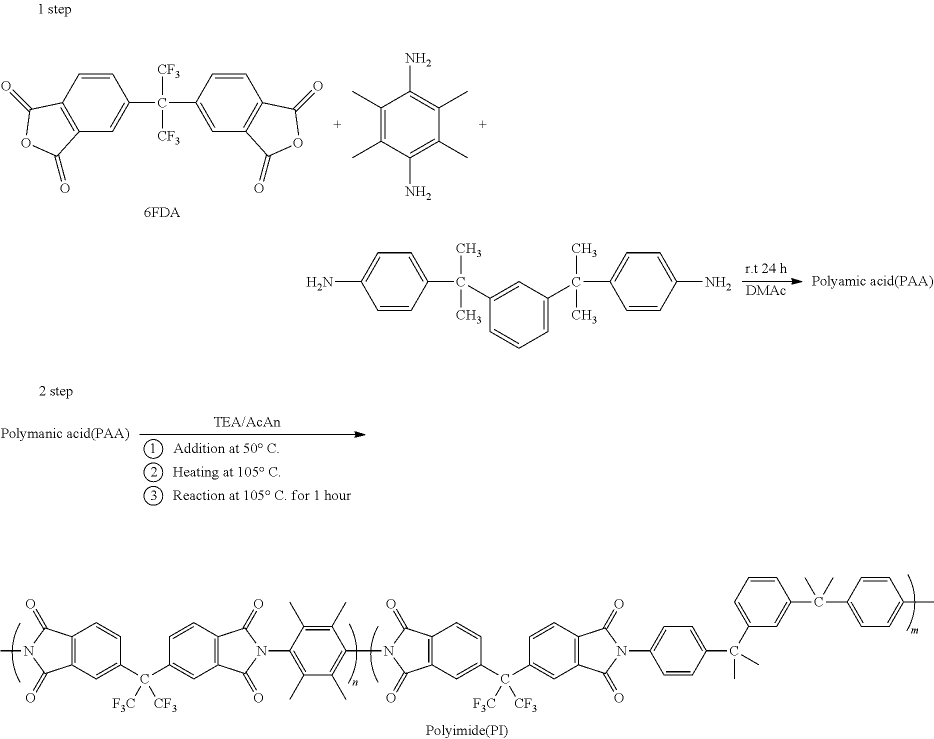

In Reaction Formula 1, n and m may be each independently integers of 10 to 1000.

First, the synthesizing of the polyamic acid containing 4,4′-(hexafluoroisopropylidene)diphthalic anhydride (6-FDA), 2,3,5,6-tetramethyl-1,4-phenylenediamine (4MPD), and 1,3-bis[2-(4-aminophenyl)-2-propyl]-benzene (BAPB) will be described in detail.

First, the synthesizing of the polyamic acid may include adding a DMAc solution to 6-FDA, 4MPD, and BAPB to dissolve 6-FDA, 4MPD, and BAPB. 6-FDA may be polymerized with an aromatic diamine to thereby obtain a soluble polyimide, and it is known that this polyimide has high gas permeability and selective permeability. According to an exemplary embodiment of the present invention, the polyamic acid may be prepared by dissolving 6-FDA and 4MPD-BAPB in the DMAc solution. A preparation environment is not particularly limited, but the polyamic acid may be prepared under nitrogen atmosphere, and stirring may be performed. In this case, it is preferable that the stirring is performed at room temperature for 6 to 24 hours, but is not limited thereto.

The polyamic acid, which is a primary reaction product, is synthesized by stirring the solution. Next, the imidizing of the polyamic acid to prepare a polyimide will be described in detail.

The polyimide is prepared by performing a secondary reaction on the polyamic acid prepared after the primary reaction. In detail, after the prepared polyamic acid is heated to 50 to 105° C., acetic anhydride (AcAn) and triethylamine (TEA) are slowly added thereto and stirred, such that the polyimide may be prepared. A stirring time of the secondary reaction is preferably 2 to 4 hours, but is not limited thereto. In this case, an exothermic reaction may occur.

A sum of concentrations of three monomers used at the time of dissolving 6-FDA and 4MPD-BAPB in the DMAc is not particularly limited, but the monomers may be injected at an amount of 1 to 10 g per 100 mL of a DMAc mixed solvent. In addition, a content ratio of 6-FDA and 4MPD-BAPB is not particularly limited, but it is preferable that the content ratio of 6-FDA and 4MPD-BAPB is 2(6-FDA):8(4MPD-BAPB) to 8(6-FDA):2(4MPD-BAPB).

A ratio of the used diamines may be 1(4MPD):9(BAPB) to 9(4MPD):1(BAPB), and the ratio may be confirmed through a specific peak integration of each amine using 1H nuclear magnetic resonance (NMR). In the case in which an equivalent ratio of the amines with 6-FDA is not accurately adjusted, it is difficult to produce a polyimide having a high molecular weight. Therefore, the polyimide having a high molecular weight may be obtained by adjusting contents of 6-FDA and 4MPD-BAPB to have the accurate equivalent ratio according to the present invention.

In detail, the molecular weight of the polyimide prepared by the method of preparing a polyimide according to the present invention may be 150,000 to 1,000,000 (g/mol) and the polydispersity index thereof may be 1.5 to 3.5. In the case in which a weight average molecular weight of the polyimide is less than 150,000, performance of a gas separation membrane may be deteriorated, and in the case in which the weight average molecular weight thereof is more than 1,000,000, at the time of manufacturing a gas separation membrane, a polymer is not dissolved in a solvent, such that it is difficult to manufacture the gas separation membrane. Further, in the case in which a polydispersity index of a polyimide is less than 1.5, there is no problems in physical properties, but the polyimide is out of the range according to the method of preparing a polyimide according to the present invention, and in the case in which the polydispersity index thereof is more than 3.5, gas permeability and selectivity are not uniformly measured.

The present invention may provide a method of manufacturing a gas separation membrane containing the polyimide prepared as described above.

As described above, the present invention provides 6FDA-4MPD-BAPB polyimide prepared by the mechanism of Reaction Formula 1, and the 6FDA-4MPD-BAPB polyimide may be used in a gas separation membrane.

With the method of preparing a polyimide according to the present invention, a novel 6FDA-4MPD-BAPB polyimide having a weight average molecular weight of 150,000 to 1,000,000 (g/mol) and a polydispersity index of 1.5 to 3.5 may be synthesized.

Further, the 6FDA-4MPD-BAPB polyimide according to the present invention has excellent gas permeation characteristics such as oxygen permeability of 20 to 120 Barrers and oxygen selectivity of 2 to 6.

Therefore, the gas separation membrane manufactured by the method according to the present invention may have excellent characteristics such as oxygen permeability of 20 to 120 and oxygen/nitrogen selectivity of 2 to 6.

In addition, the present invention includes the gas separation membrane manufactured using the polyimide prepared by the above-mentioned method, and the gas separation membrane may be manufactured by various methods.

Meanwhile, according to the exemplary embodiment of the present invention, the manufacturing of the gas separation membrane may further include purifying the polyimide.

In detail, the present invention may provide a method of manufacturing a gas separation membrane further including purifying the polyimide using a mixed solvent of methanol and dimethylacetamide (DMAc). In this case, a content ratio of methanol and N,N-dimethylacetamide in the mixed solvent may be 1:1 to 10, but is not necessarily limited thereto.

For example, the polyimide that is purified or not purified is dissolved in a membrane-forming solvent to prepare a uniform membrane-forming solution, applying the uniform membrane-forming solution on a suitable substrate (a glass plate, a glass petri dish, or the like), and treating the applied membrane-forming solution at room temperature, heat-treating the applied membrane-forming solution, or heat-treating the applied membrane-forming solution under reduced pressure and evaporating the solvent, thereby forming a uniform membrane. In general, the membrane is manufactured so as to have a thickness of 50 to 150 μm.

As described above, the gas separation membrane manufactured to contain the polyimide prepared by the method of preparing a polyimide according to the present invention is included in the scope of the present invention.

Further, the gas separation membrane manufactured to contain the polyimide prepared by the method of preparing a polyimide according to the present invention is included in the scope of the present invention.

In addition, the gas separation membrane containing the polyimide according to the present invention is also included in the scope of the present invention.

### Advantageous Effects

With a method of preparing a polyimide according to the present invention, a polyimide having a high molecular weight, a low polydispersity index, and excellent oxygen permeability and oxygen/nitrogen selectivity may be provided, and thus, the polyimide may be used as a polymer material having high permeability and high oxygen selectivity and widely used in a gas separation membrane field.

### BEST MODE

Hereinafter, Examples will be provided in order to describe the present invention in more detail. However, the present invention is not limited to the following Examples.

### Example 1

### Synthesis of Polymer Material (Polyimide (PI)) for OBIGGS and Manufacturing of Membrane

1) Synthesis of PI

\textcircled{1} Synthesis of Polyamic Acid (PAA)

After 2,3,5,6-tetramethyl-1,4-phenylenediamine (4MPD) and 1,3-bis[2-(4-aminophenyl)-2-propyl]-benzene (BAPB) corresponding to diamines were mixed with each other at a content ratio of 5:5 in a 5-neck round bottom flask under dried nitrogen atmosphere, 57 wt % of the diamine mixture and 43 wt % of 4,4′-(hexafluoroisopropylidene)diphthalic anhydride were mixed, and N,N-dimethylacetamide (DMAc) corresponding to a solvent was added thereto so as to have a monomer concentration of 150 (w/w), followed by stirring at room temperature for 24 hours, thereby synthesizing a polyamic acid.

\textcircled{2} Chemical Synthesis of Polyimide

After the prepared polyamic acid was heated to 50° C., acetic anhydride (AcAn) and triethylamine (TEA) were each slowly added thereto at a molar ratio of 4 times that of a 4,4′-(hexafluoroisopropylidene)diphthalic anhydride monomer and stirred. After the reaction mixture was heated to 105° C. and stirred for 1 hour, a reaction was carried out at 105° C. for 1 hour. 1H nuclear magnetic resonance (NMR) and infrared (IR) spectra of a prepared polyimide were measured.

In order to analyze a structure of the prepared polyimide, the structure was measured using nuclear magnetic resonance (NMR), and in 1H NMR spectra, a methyl peak of 1,3-bis[2-(4-aminophenyl)-2-propyl]-benzene (BAPB) was confirmed at 1.63 (12H, d, 4×CH₃), a methyl peak of 2,3,5,6-tetramethyl-1,4-phenylenediamine (4MPD) was confirmed at 2.04 (12H, d, 4×CH₃), and at the time of using two amines, an actual reaction ratio may be confirmed by NMR through 4MPD CH₃ peak (2.04 ppm) and BAPB CH₃ peak of BAPB (1.63 ppm), which were methyl peaks of 4MPD and BAPB, respectively.

Further, in order to determine whether or not the prepared polyimide was synthesized, Fourier Transform IR (FT-IR) spectroscopy was used: C═O asymmetrical stretching amide peak appeared at 1785 cm¹, C═O symmetrical stretching amide peak appeared at 1721 cm⁻¹, and C—N stretching appeared at 1354 cm⁻¹.

2) Synthesis of 6FDA-4MPD-BAPB Polyimide Copolymer and Measurement of Physical Properties Thereof

A reflux condenser was installed on a 5-neck round bottom flask, and 43 g of 6-FDA, 28.5 g of 2,3,5,6-tetramethyl-1,4-phenylenediamine (4MPD), and 28.5 g of BAPB were added to 650 mL of DMAc under nitrogen atmosphere and stirred at room temperature for 24 hours. After stirring, 70 mL of AcAn and 70 mL of TEA were added thereto and heated to 50° C. for 1 hour, and slowly heated to 105° C. for 1 hour, and then, a reaction was additionally carried out at 105° C. A brown mixture produced by the reaction was put into 1 L of a mixed solvent of methanol and DMAc (50:50 (wt %)) so as to be precipitated, thereby performing purification. Then, the resultant was washed several times with methanol, thereby obtaining a 6FDA-4MPD-BAPB polyimide copolymer as white powder. The obtained polyimide was dried in a vacuum oven at 150° C. for 24 hours.

In order to analyze a structure of the prepared polyimide, the structure was measured using nuclear magnetic resonance (NMR), and 1H NMR confirmed a methyl peak of 1,3-bis[2-(4-aminophenyl)-2-propyl]-benzene (BAPB) at 1.63 (12H, d, 4×CH₃), a methyl peak of 2,3,5,6-tetramethyl-1,4-phenylenediamine (4MPD) at 2.04 (12H, d, 4×CH₃), and at the time of using two amines, an actual reaction ratio may be confirmed by NMR through 4MPD CH₃ peak (2.04 ppm) and BAPB CH₃ peak of BAPB (1.63 ppm), which were methyl peaks of 4MPD and BAPB, respectively.

Further, in order to determine whether or not the prepared polyimide was synthesized, Fourier Transform IR (FT-IR) spectroscopy was used: C═O asymmetrical stretching amide peak appeared at 1785 cm¹, C═O symmetrical stretching amide peak appeared at 1721 cm⁻¹, and C—N stretching appeared at 1354 cm⁻¹.

In addition, thermogravimetric analysis (TGA) of the polyimide was performed. At the time of performing TGA, a temperature when a weight was decreased by 5% was about 534° C., such that it may be appreciated that the polyimide had a significantly high pyrolysis temperature.

Further, in order to confirm whether or not a polyimide having a high molecular weight was formed, a molecular weight of the prepared polyimide was measured using Tosoh GPC system (Tosoh Corp., HLC-8320, JP). A number average molecular weight (Mn) of the prepared polyimide was 84,260, a weight average molecular weight thereof was 183,361, and a polydispersity index (PDI, Mw/Mn) thereof was 2.2.

Further, solubility of the formed polymer was measured. A solubility value thereof was illustrated in the following Table 2, and it was confirmed that the formed polymer was easily dissolved in most of the organic solvents.

3) Manufacturing of Gas Separation Membrane and Measurement of Properties of Gas Separation Membrane

2 wt % of the dried polyimide was dissolved in an amylene-stabilized chloroform solvent and stirred for 12 hours. The resultant was filtered after stirring and poured on a glass petri dish, followed by natural drying at room temperature for 48 hours.

After the dried film was immersed in water to thereby be separated, the remaining solvent was completely removed by putting the separated film in methanol. The obtained film was kept at room temperature for one day to remove the remaining methanol, thereby manufacturing a polyimide membrane having a thickness of 75 μm.

In order to confirm properties of the polyimide membrane manufactured as described above as the gas separation membrane, gas permeability and selectivity were measured. Gas permeability is an index indicating a permeation rate of oxygen with respect to a membrane, and a unit thereof is represented by the following Equation 1. (Measured data are values at 30° C. and 1,780 torr.)

Barrer=10⁻¹⁰ cm³(STP)cm/cm² sec cmHg [Equation 1]

In Equation 1: cm refers to a thickness of a film; cm² refers to an area of the film; sec refers to a time (second); and cmHg refers to an upper pressure.

Selectivity is indicated as a ratio of gas permeability separately measured with respect to individual gas using the same membrane.

The gas permeability and selectivity measured as described above were illustrated in the following Table 3. O₂/N₂=4.9, which is a measured selectivity value, indicates that a permeation rate of O₂ gas was 4.9 times that of N₂ gas. (Measured data are values at 30° C. and 1,780 torr.)

### Example 2

A polyimide copolymer was prepared by the same method as in Example 1 except for changing the content ratio of 4MPD and BAPB to 8(4MPD):2(BAPB).

A molecular weight of the formed polyimide copolymer was measured by the method of Example 1. A number average molecular weight (Mn) of the prepared polyimide was 68,182, a weight average molecular weight thereof was 175,993, and a polydispersity index (PDI, Mw/Mn) thereof was 2.7 (Table 1).

Further, solubility thereof was measured and illustrated in the following Table 2.

A gas separation membrane was manufactured by the same method as in Example 1 using the polyimide copolymer of Example 2, and properties of the gas separation membrane were measured by the same method as in Example 1. Measured values were illustrated in the following Table 3. It may be confirmed that in the case of the gas separation membrane of Example 2, gas permeability was high, but selectivity was significantly low as compared to Example 1.

### Example 3

A polyimide copolymer was prepared by the same method as in Example 1 except for changing the content ratio of 4MPD and BAPB to 2(4MPD):8(BAPB).

A molecular weight of the formed polyimide copolymer was measured by the method of Example 1. A number average molecular weight (Mn) of the prepared polyimide was 58,923, a weight average molecular weight thereof was 170,878, and a polydispersity index (PDI, Mw/Mn) thereof was 2.9 (Table 1).

Further, solubility thereof was measured and illustrated in the following Table 2.

A gas separation membrane was manufactured by the same method as in Example 1 using the copolymer of Example 3, and gas permeability thereof was measured. Measured values were illustrated in the following Table 3. It may be confirmed that in the case of the gas separation membrane of Example 3, selectivity was high, but gas permeability was significantly low as compared to Example 1.

### Comparative Example 1

In Comparative Example 1, a polyimide copolymer was prepared by the same method as in Example 1 except for using only 4MPD as the diamine and mixing 6-FDA and 4MPD with each other at a content ratio of 5(6-FDA):5(4MPD).

A molecular weight of the formed polyimide copolymer was measured by the method of Example 1. A number average molecular weight (Mn) of the prepared polyimide was 28,465, a weight average molecular weight thereof was 105,232, and a polydispersity index (PDI, Mw/Mn) thereof was 3.7 (Table 1).

Further, solubility thereof was measured and illustrated in the following Table 2.

A gas separation membrane was manufactured by the same method as in Example 1 using the copolymer of Comparative Example 1, and gas permeability thereof was measured. Measured values were illustrated in the following Table 3. It may be confirmed that in the case of the gas separation membrane of Comparative Example 1, gas permeability was high, but selectivity was significantly low as compared to Example 1.

### Comparative Example 2

In Comparative Example 2, a polyimide copolymer was prepared by the same method as in Example 1 except for using only BAPB as the diamine and mixing 6-FDA and 4BAPB with each other at a content ratio of 5(6-FDA):5(BAPB).

A molecular weight of the formed polyimide copolymer was measured by the method of Example 1. A number average molecular weight (Mn) of the prepared polyimide was 38,585, a weight average molecular weight thereof was 123,472, and a polydispersity index (PDI, Mw/Mn) thereof was 3.2 (Table 1).

Further, solubility thereof was measured and illustrated in the following Table 2.

A gas separation membrane was manufactured by the same method as in Example 2 using the copolymer of Comparative Example 1, and gas permeability thereof was measured. Measured values were illustrated in the following Table 3. It may be confirmed that in the case of the gas separation membrane of Comparative Example 2, selectivity was high, but gas permeability was significantly low as compared to Example 1.

TABLE 1

| | Mn | Mw | PDI (Mw/Mn) |
|---|---|---|---|
| Example 1 | 84,260 | 183,361 | 2.2 |
| Example 2 | 65,182 | 175,993 | 2.7 |
| Example 3 | 58,923 | 170,878 | 2.9 |
| Comparative Example 1 | 28,465 | 105,232 | 3.7 |
| Comparative Example 2 | 38,585 | 123,472 | 3.2 |

TABLE 2

| | Solubility (6FDA:4MPD:BABP) | | | | |
|---|---|---|---|---|---|
| | | | | Comparative | Comparative |
| Solvent | Example 1 | Example 2 | Example 3 | Example 1 | Example 2 |
| Acetone | X | X | X | X | ◯ |
| Chloroform | ◯ | ◯ | ◯ | ◯ | ◯ |
| Dimethylacetamide | ◯ | ◯ | ◯ | ◯ | ◯ |
| Dimethylformamide | ◯ | ◯ | ◯ | ◯ | ◯ |
| N-methyl-2-pyrrolidone | ◯ | ◯ | ◯ | ◯ | ◯ |
| Methylenechloride | ◯ | ◯ | ◯ | ◯ | ◯ |
| Tetrahydrofuran | ◯ | ◯ | ◯ | ◯ | ◯ |
| Toluene | X | X | X | X | X |
| Hexane | X | X | X | X | X |
| Methanol | X | X | X | X | X |
| Ethanol | X | X | X | X | X |
| Isopropylalcohol | X | X | X | X | X |
| Water | X | X | X | X | X |
| Ethylacetate | ◯ | ◯ | ◯ | X | ◯ |

TABLE 3

| | Gas Permeability | | Oxygen |
|---|---|---|---|
| | (barrer) | | Selectivity |
| | O₂ | N₂ | O₂/N₂ |
| Example 1 | 44 | 8.9 | 4.9 |
| Example 2 | 118 | 47.2 | 2.5 |
| Example 3 | 23 | 4.3 | 5.4 |
| Comparative Example 1 | 125 | 39.1 | 3.2 |
| Comparative Example 2 | 8 | 1.34 | 5.98 |
| Matrimid ® | 1.32 | 0.18 | 7.3 |
| polyimide | | | |
| Udel ® polysulfone | 1.06 | 0.15 | 7.1 |

Further, in Table 3, it may be confirmed that in the cases of Examples 1 to 3, numerical values of gas permeability were significantly different depending on a ratio of the used amine.

In Example 1, the molecular weight was high, oxygen permeability was 44, and nitrogen permeability was 8.9. Therefore, it was confirmed that oxygen permeability was low but the numerical value of selectivity was high as compared to Comparative Example 1, and numerical values of gas permeability was high as compared to Comparative Example 2.

Further, it may be appreciated that the gas separation membranes of Examples 1 to 3 had significantly high oxygen permeability as compared to Matrimid® polyimide and Udel® polysulfone, which are commercialized polyimides.

1. A polyimide comprising 4,4′-(hexafluoroisopropylidene)diphthalic anhydride, 2,3,5,6-tetramethyl-1,4-phenylenediamine, and 1,3-bis[2-(4-aminophenyl)-2-propyl]-benzene.

2. The polyimide of claim 1, wherein a content ratio of 2,3,5,6-tetramethyl-1,4-phenylenediamine and 1,3-bis[2-(4-aminophenyl)-2-propyl]-benzene is 1:9 to 9:1.

3. The polyimide of claim 1, wherein a molecular weight of the polyimide is 150,000 to 1,000,000 (g/mol) and a polydispersity index thereof is 1.5 to 3.5.

4. A method of manufacturing a gas separation membrane, the method comprising:
synthesizing a polyamic acid containing 4,4′-(hexafluoroisopropylidene)diphthalic anhydride, 2,3,5,6-tetramethyl-1,4-phenylenediamine, and 1,3-bis[2-(4-aminophenyl)-2-propyl]-benzene; and
imidizing the polyamic acid to prepare a polyimide.

5. The method of claim 4, wherein a molecular weight (Mw) of the polyimide is 150,000 to 1,000,000 (g/mol) and a polydispersity index (PDI) thereof is 1.5 to 3.5.

6. The method of claim 4, further comprising purifying the polyimide using a mixed solvent of methanol and N,N-dimethylacetamide (DMAc).

7. The method of claim 4, wherein oxygen permeability of the polyimide is 20 to 120 Barrers, and oxygen selectivity thereof is 2 to 6.

8. A gas separation membrane manufactured by the method of claim 4.

9. A gas separation membrane manufactured by the method of claim 5.

10. A gas separation membrane manufactured by the method of claim 6.

11. A gas separation membrane manufactured by the method of claim 7.
